(19) United States
(12) Patent Application Publication
(10) Pub. No.: US 2024/0199119 A1
(43) Pub. Date: Jun. 20, 2024

(54) Power Steering Assembly With Targeted and Adjustable Compensation of Roadside Shock Pulses to the Steering Gear and Method for Designing a Power Steering Assembly

(71) Applicant: KNORR-BREMSE Systeme fuer Nutzfahrzeuge GmbH, Muenchen (DE)

(72) Inventors: Dirk LETTOW, Wuppertal (DE); Jens-Hauke Mueller, Velbert-Neviges (DE); Sven KIRSCHBAUM, Mettmann (DE); Dimitri EPSTEIN, Wuppertal (DE)

(21) Appl. No.: 18/286,952

(22) PCT Filed: Mar. 28, 2022
(86) PCT No.: PCT/EP2022/058158

§ 371 Date: Oct. 13, 2023

(30) Foreign Application Priority Data
Apr. 16, 2021 (DE) 10 2021 109 655.3

(51) Int. Cl. B62D 7/22; B62D 5/24

(52) U.S. Cl. CPC B62D 7/226; B62D 5/24; B62D 7/224

(57) ABSTRACT

A power steering assembly for an electromechanical power steering system of motor vehicles, in particular utility vehicles, includes a steering gear, the steering gear being designed to transmit a rotational movement introduced by a steering element such as a steering wheel, via an input side of the steering gear, to an output side of the steering gear. The power steering assembly converts a movement derived from the output side of the steering gear into a rotational movement of at least one wheel of the motor vehicle about a steering axis. An adjustable absorption unit is provided for at least partially absorbing roadside shocks which have been absorbed via the wheel of the motor vehicle. A separate preloading unit is designed to interact with the adjustable absorption unit such that a predetermined preloading force is exerted onto the adjustable absorption unit.

### BACKGROUND AND SUMMARY

The present invention relates to a power steering assembly for electromechanical power steering in motor vehicles. The invention further relates to a method for setting up a power steering assembly for electromechanical power steering in motor vehicles.

Multiple power steering assemblies are known from the prior art. Here, power steering assemblies mainly comprise several components sensitive to mechanical loads, particularly with respect to the steering gear incorporated in the power steering assembly. For example, the steering gear usually comprises a spindle and a ball screw nut with ball bearings or a ball chain, as well as in addition gear pairings in the form of external gear teeth on the ball screw nut, for example, which engage with segment gear teeth on a segment shaft. These components are particularly sensitive to abruptly applied mechanical forces or loads.

One source of abruptly applied loads of this kind is, for example, road-induced impact forces. Hence, irregularities in the road surface can result in shocks on the motor vehicle which can result in unwanted abrupt movements in a power steering assembly, for example. In the prior art, the shock absorber system of the suspension system is typically solely responsible for compensating for road-induced shocks. However, there is room for improvement in a system of this kind, insofar as the loads or stresses introduced into sensitive components of a steering gear could be compensated for, or absorbed, in a more targeted manner.

This problem is explained below using the example of a commercial vehicle, wherein this should not be understood as limiting the scope of the present invention. Commercial vehicles typically have power steering assemblies with ball screw steering. The power steering assembly comprises a steering gear for this purpose, which is set up to transmit a rotational movement introduced by a steering device, such as a steering wheel, through an input side of the steering gear to an output side of the steering gear. The input side in this case can be formed by an input shaft, for example, and the output side by an output shaft, in the form of a segment shaft, for example. Within the steering gear, the rotational movement introduced by the input shaft can then be converted in the intended manner, in that the input shaft is designed as a spindle, and its rotational movement ensures a translational movement of a ball screw nut surrounding the spindle section, wherein this translational movement can likewise be referred to as axial movement of the ball screw nut, or also of the piston. In turn, the ball screw nut is typically provided with external gear teeth. The ball screw nut can, in turn, ensure with the external gear teeth which mesh with segment gear teeth on the segment shaft that the translational movement of the ball screw nut is converted into a rotational movement of the segment shaft or output shaft and is thereby derived at the output side of the steering gear. A steering column lever, and a tie rod connected thereto in an articulated manner, is then typically attached to this output side. The tie rod of the power steering assembly ultimately absorbs the rotational movement derived from the output side of the steering gear and, during a steering maneuver, performs a translational tie rod movement, as intended—also known as axial movement. In this case, this translational tie rod movement brings about an intended rotational movement of at least one wheel of the motor vehicle about a steering axle.

In power steering assemblies constructed in this manner, road-induced impact forces can lead to abrupt movements in many of the aforementioned components of the power steering assembly, which in turn result in unwanted loads or stresses being introduced into the interior of the steering gear. Forces or loads and stresses of this kind in prior-art power steering assemblies have hitherto usually been compensated for mainly by the hydraulics of the power steering assemblies.

Moreover, it is typical in the prior art for a large amount of work to be required for the design of power steering assemblies of this kind for the specific application in each case. As a result, very precise, elaborate design and manufacturing processes are often necessary, so that the switching point of potentially provided damping elements for a steering gear or for a power steering assembly can be correctly defined. This leads to problems in that, if the individual components installed in principle are not properly designed or produced, it can result in more indirect steering response. An individual, application-specific design of the steering gears for the power steering assemblies must take place, which is time-consuming and costly, in order to avoid negative consequences of this kind, for example, in the form of indirect steering response. The corresponding methods for setting up a power steering assembly are therefore very complex in the prior art for these reasons.

Against this background, the object of the invention is to develop a power steering assembly of the kind referred to above, in such a manner that the steering gear is better protected against road-induced impact forces. Moreover, the amount of work required for design and manufacturing should be reduced, and indirect steering response avoided in the simplest way possible. The invention is therefore also based on the object of providing a method for setting up a power steering assembly for electromechanical power steering for motor vehicles that requires less work for the effective avoidance of indirect steering response.

This object is achieved by a power steering assembly and by a method in accordance with the independent claims. Further, particularly advantageous embodiments of the invention are disclosed by the dependent claims.

Essential to the invention is the underlying consideration that the power steering assembly should be configured in such a manner that in the context of the power steering assembly, its own adjustable absorption unit is provided, as intended, selectively to protect the steering gear from loads or stresses resulting from road-induced impact forces. For this purpose, the adjustable absorption unit selectively compensates for such movements, and the resulting loads, by converting kinetic energy into potential energy within the adjustable absorption unit. Forces or loads in the steering gear that would be substantially undamped or would not be attenuated, were it not for the adjustable absorption unit, or would only be damped or compensated for by the hydraulics of the power steering, are reduced. For this purpose, the adjustable absorption unit is set up to convert kinetic energy into potential energy and ensures that vibrations are selectively cushioned or absorbed. The adjustable absorption unit is preferably elastically designed for this purpose. The adjustable absorption unit is advantageously set up in such a manner that at least small relative movements of the neighboring components of the power steering assembly adjacent to the adjustable absorption unit are allowed.

Furthermore, a key insight for the invention is that the disadvantages of the prior art that have been described can be avoided by providing, in addition, a separate preload unit that can be used to adjust the adjustable absorption unit. In this way, a preload force individually adapted to the respective application can be set in the adjustable absorption unit, in that the separate preload unit compresses the adjustable absorption unit by a desired amount in a simple manner. In this way, the adjustable absorption unit can easily be adjusted in precisely such a manner that an indirect steering response can be effectively avoided. This also substantially reduces the work involved in the manufacturing processes of power steering assemblies and, in particular, in designing power steering assemblies. This means that very precise, elaborate design and manufacturing processes are no longer necessary, in order to correctly define the switching point of the adjustable absorption unit. As a result, even in the event that components are not correctly designed or produced, a more indirect steering response can be effectively avoided, in that the separate preload unit simply preloads the adjustable absorption unit by the desired amount.

The power steering assembly proposed for electromechanical power steering in motor vehicles, which may, in particular, be a power steering assembly for electromechanical power steering in commercial vehicles, comprises a steering gear. This steering gear is set up to transmit a rotational movement introduced by a steering input device via an input side of the steering gear to an output side of the steering gear. The steering input device may, in particular, be a steering wheel. The rotational movement that has been introduced may, in particular, be introduced via an input shaft of the steering gear. According to the proposal, the power steering assembly is set up to convert a movement derived from the output side of the steering gear into a rotational movement of at least one wheel of the motor vehicle about a steering axle.

The proposed power steering assembly is characterized in that an adjustable absorption unit is provided for the at least partial absorption of road-induced shocks received through the wheel of the motor vehicle. Furthermore, a separate preload unit is provided according to the proposal, which separate preload unit is set up to interact with the adjustable absorption unit in such a way that a predetermined preload force is applied to the adjustable absorption unit.

The proposed method for setting up a power steering assembly for electromechanical power steering in motor vehicles is, in particular, a method for setting up a proposed power steering assembly, as described above or below.

The proposed method is characterized in that an adjustable absorption unit for the at least partial absorption of road-induced shocks received through the wheel of the vehicle is integrated into the transformation path of the steering movement of the entire power steering assembly. Furthermore, a separate preload unit is provided according to the proposal, and finally a predetermined preload force is set, which predetermined preload force is applied to the adjustable absorption unit by the separate preload unit compressing the adjustable absorption unit.

In principle, the adjustable absorption unit can be compressed to any desired predetermined extent, at least in parts (for example, at least one elastic element or a group of elastic elements, in the event that the adjustable absorption unit is formed by multiple, differently arranged, elastic elements). In this case, “any desired” should of course be understood to mean an amount within certain limits, so within a range adapted to the installation space. For example, either one compensating disc, or also multiple compensating discs, of a specific thickness can be provided to compress the adjustable absorption unit by that thickness. Typically, the adjustable absorption unit is preferably simply pressed together by the separate preload unit in the axial direction for this purpose, as arranging the compensating disk reduces the installation space remaining for the adjustable absorption unit. Alternatively, preload nuts can also be provided as a separate preload unit or differently designed components, which have a thread engaging with a counter-thread. In this case, the degree of compression of the adjustable absorption unit can be advantageously set individually by turning the threaded component into the counter-thread by a desired amount and thereby compressing the adjustable absorption unit by that amount.

In principle, the adjustable absorption unit, as proposed, is specifically integrated in the power steering assembly and is a component thereof. For this purpose, the absorption unit may, for example, be integrated into the transformation path of the steering movement of the entire assembly, in other words viewed from the steering input device, for example the steering wheel, in the direction of the wheel being steered between the input side of the steering gear and the tie rod responsible for steering, for example.

As a result, abrupt movements in the proposed power steering assembly are advantageously compensated for by the adjustable absorption unit and the resulting loads are at least partially absorbed. In this way, the shock impulses, when they, or the resulting forces from the road, are transmitted either through the wheel to a tie rod and possibly to the other components of the power steering assembly that are connected to the provided tie rod, for example, or also through the housing of the steering gear, are selectively cushioned or compensated for. This means that the hydraulic system of the power steering assembly is no longer solely responsible for this kind of compensation for road-induced impact forces, and therefore the steering gear of the proposed power steering assembly, and in particular the sensitive components arranged within the steering gear, are better protected against road-induced impact forces.

In principle, the input side of the steering gear may be formed by an input shaft, wherein the input shaft may be designed, in particular, as a spindle. The output side of the steering gear may, in turn, typically be formed by an output shaft, preferably a segment shaft. The movement derived from the output side of the steering gear may be directly or indirectly transferred from the output side, for example via the segment shaft, to a tie rod, for example. The output shaft can therefore be connected to a steering column lever fixedly, in particular in a non-rotatable or rotationally fixed manner. The steering column lever can then receive a rotational movement from the output shaft and also perform a rotational movement. Then, for example, at the end of the steering column lever facing away from the output shaft, a ball joint can be provided which connects the steering column lever to the tie rod. Accordingly, the ball joint can ensure that the movement derived from the output side of the steering gear, in the form of the rotational movement of the output shaft and therefore the rotational movement of the steering column lever, is transmitted to the tie rod to perform a translational tie rod movement.

In an embodiment of this kind with a tie rod, the tie rod is therefore provided to receive the movement derived from the output side of the steering gear and to perform a translational tie rod movement, wherein the tie rod is arranged in such a manner that the translational tie rod movement induces the rotational movement of the least one wheel of the motor vehicle about the steering axle.

The adjustable absorption unit can, in principle, be advantageously arranged in such a manner as to be integrated in the steering gear, and is preferably arranged between the input side and the output side of the steering gear. The adjustable absorption unit may, in principle, be designed as an elastic element, such as elastomer or a spring package, or multiple elastic elements can also be provided as the adjustable absorption unit. In principle, relative movements of adjacent components can be allowed by the elastic element, or the elastic elements, of the adjustable absorption unit, as a result of which kinetic energy is absorbed by means of the adjustable absorption unit, which achieves the desired compensating effect. It can preferably be provided, in principle, that the adjustable absorption unit is formed from at least one elastic element, in particular from at least one disk spring and/or from at least one coil spring and/or from at least one elastomer.

In principle, it can be advantageously provided that the steering gear has an input shaft designed as a spindle and a ball screw nut for translating the rotational movement of the input shaft into a translational movement, wherein a tooth section is provided surrounding the ball screw nut on the outer side. It can be provided in this case that the adjustable absorption unit is arranged in such a manner that the translational movement of the ball screw nut is transferred to the tooth section via the adjustable absorption unit, and vice versa. In this way, road-induced shock impulses can be effectively compensated for in a particularly advantageous manner within the steering gear itself.

Alternatively or in addition, it may also be advantageously provided that the steering gear has an input shaft designed as a spindle and a ball screw nut for translating the rotational movement of the input shaft into a translational movement, and that the adjustable absorption unit is at least partially formed as an axial elastic spindle bearing for the input shaft. In this way, road-induced shock impulses can be effectively compensated for on the input side of the steering gear in a particularly advantageous manner.

In addition, it can be advantageously provided that the adjustable absorption unit formed as an axial elastic spindle bearing for the input shaft is formed by at least one elastic element, in particular by at least one disk spring, wherein the at least one elastic element is arranged adjacent to a bearing arrangement of the input shaft for the rotatable bearing of the input shaft in a housing, in such a manner that the bearing arrangement of the input shaft is received in the housing axially elastically via the at least one elastic element. “Axially elastically” should be particularly understood to mean axially to the input shaft. It has been surprisingly recognized by the present invention that despite the extra constructive effort in the form of the addition to the bearing arrangement of the input shaft, the cost-effectiveness of the power steering assembly as a whole can nevertheless be increased. This is because sensitive components of the steering gear are advantageously selectively protected from road-induced shock impulses and their durability is thereby increased.

It can also be advantageously provided in principle that the input shaft designed as a spindle is designed in multiple parts by at least one spindle section facing the ball screw nut and an input section, and that the spindle section and the input section are rotationally fixed but axially elastically connected to one another via the adjustable absorption unit formed as an axial elastic spindle bearing for the input shaft, preferably in the form of at least one elastic element, particularly preferably in the form of annular springs. It has been surprisingly recognized by the present invention that despite the additional design-related work involving dividing the input shaft and, in particular, despite the actual weakening of the input shaft, and therefore of the entire power steering assembly, associated with this, the durability of the power steering assembly as a whole can still be increased. This is because sensitive components of the steering gear are advantageously selectively protected from road-induced shock impulses.

A preferred embodiment of the power steering assembly is characterized in that the separate preload unit comprises at least one first compensation washer. This allows the preload force on the adjustable absorption unit to be individually tailored in a particularly straightforward manner. Individual adaptability to the application of the power steering assembly is possible without the need for complex design of the individual components, in particular the elastic elements of the adjustable absorption unit. In addition, inaccuracies in the manufacture of the power steering assembly can also be effectively compensated for. The first compensation washer preferably forms a direct contact surface as the contact surface for the adjustable absorption unit or some elastic elements thereof.

In addition, it may preferably be provided that the separate preload unit also comprises at least one second compensation washer. In particular, the second compensation washer may have a second thickness that differs from a first thickness of the first compensation washer. This allows for particularly easy adjustments to the specific application of the power steering assembly. Individual adaptability to the application of the power steering assembly is possible without the need for complex design of the individual components, in particular the elastic elements of the adjustable absorption unit. In addition, inaccuracies in the manufacture of the power steering assembly can also be effectively compensated for. The first compensation washer and the second compensation washer are preferably arranged immediately adjacent to one another.

According to another embodiment of the power steering assembly, it is provided that the separate preload unit comprises a preload nut. This allows the preload force on the adjustable absorption unit to be individually tailored in a particularly straightforward manner. Individual adaptability to the application of the power steering assembly is possible without the need for complex design of the individual components, in particular the elastic elements of the adjustable absorption unit. In addition, inaccuracies in the manufacture of the power steering assembly can also be effectively compensated for. The preload nut can simply be turned further into the matching counter-thread, in order to increase the preload force. Further preferably, the preload nut has an end face that forms a direct contact surface as the contact surface for the adjustable absorption unit or some elastic elements thereof.

According to another embodiment of the power steering assembly, it is provided that the separate preload unit is set up to interact with the adjustable absorption unit in such a manner that the predetermined preload force is adjustable by means of two components engaging with one another via thread and counter-thread, preferably substantially continuously. “Substantially continuously” in this context should be understood to mean that arbitrarily high or low values cannot be assumed, i.e. the components cannot be rotated to any degree in respect of one another, but can be rotated by a certain range relative to one another. Moreover, there may also be small jumps in the resulting preload force when the components are rotated in respect of one another. To this extent, the term “continuous” should not to be understood in absolute terms. This allows for easy individual adjustment of the preload force.

According to another embodiment of the power steering assembly, it is provided that the separate preload unit and the adjustable absorption unit are at least partially movable in relation to one other in the assembled state in the axial direction. This ensures effective compensation of the road-induced shocks.

According to another embodiment of the power steering assembly, it is provided that the separate preload unit is secured in the assembled state to prevent rotation in the circumferential direction, in particular by a securing pin engaging with a groove. The safety of a uniform compensating action by the adjustable absorption unit is thereby guaranteed. Any undesirable adjustment of the preload force is effectively prevented.

According to another embodiment of the power steering assembly, it is provided that the separate preload unit has an end face, which end face forms a contact surface for directly bearing against the adjustable absorption unit, for applying the predetermined preload force to the adjustable absorption unit. An effective and uniform transmission of the preload force from the preload unit to the adjustable absorption unit is thereby guaranteed.

A preferred embodiment of the method for setting up the power steering assembly is characterized in that at least one first compensation washer is provided adjacent to the adjustable absorption unit for preloading the adjustable absorption unit by targeted compression. This provides a particularly simple way of individually tailoring the preload force acting on the adjustable absorption unit. Individual adaptability to the application of the power steering assembly is possible without the need for complex design of the individual components, in particular the elastic elements of the adjustable absorption unit. In addition, inaccuracies in the manufacture of the power steering assembly can also be effectively compensated for. The method is therefore efficient and straightforward. The first compensation washer preferably forms a direct contact surface as the contact surface for the adjustable absorption unit or some elastic elements thereof.

Further preferably, it may be provided that a second compensation washer is also provided adjacent to the adjustable absorption unit for preloading the adjustable absorption unit by targeted compression. The second compensation washer in this case preferably has a second thickness that differs from a first thickness of the first compensation washer. This allows for particularly easy adjustments to the application of the power steering assembly. Individual adaptability to the application of the power steering assembly is possible without the need for complex design of the individual components, in particular the elastic elements of the adjustable absorption unit. In addition, inaccuracies in the manufacture of the power steering assembly can also be effectively compensated for. The first compensation washer and the second compensation washer are preferably arranged immediately adjacent to one another.

According to another embodiment of the method, it is provided that as the separate preload unit, a preload nut is provided adjacent to the adjustable absorption unit for preloading the adjustable absorption unit by targeted compression. This allows the preload force on the adjustable absorption unit to be individually tailored in a particularly straightforward manner. Individual adaptability to the application of the power steering assembly is possible without the need for complex design of the individual components, in particular the elastic elements of the adjustable absorption unit. In addition, inaccuracies in the manufacture of the power steering assembly can also be effectively compensated for. Preferably, the preload nut can simply be turned further into the matching counter-thread, in order to increase the preload force. Further preferably, the preload nut has an end face that forms a direct contact surface as the contact surface for the adjustable absorption unit or some elastic elements thereof.

According to another embodiment of the method, it is provided that the predetermined preload force is set by rotating a first component with a thread of the separate preload unit and a second component with a counter-thread engaging with the first component in respect of one another. The preload force can therefore preferably be set substantially continuously. “Substantially continuously” in this context should be understood to mean that arbitrarily high or low values cannot be assumed, i.e. the components cannot be rotated to any degree in respect of one another, but can be rotated by a certain range relative to one another. Moreover, there may also be small jumps in the resulting preload force when the components are rotated in respect of one another. To this extent, the term “continuous” should not be understood in absolute terms. This allows for easy individual adjustment of the preload force. The further the components are rotated in respect of one another, the higher the degree of compression of the adjustable absorption unit, i.e. also the preload force acting on it.

According to another embodiment of the method, it is provided that the separate preload unit is finally secured to prevent rotation in the circumferential direction.

In addition, it may preferably be provided that securing is achieved by providing a securing pin that engages with a groove in the circumferential direction in a form-fitting manner.

This ensures effective compensation for road-induced shocks. The safety of a uniform compensating action by the adjustable absorption unit is guaranteed, as any undesirable adjustment of the preload force is effectively prevented.

The features relating to the proposed power steering assembly described above and below, as well as the resulting advantages, are, where technically feasible, applicable to the proposed method, and vice versa.

Further features and advantages of the invention will become apparent from the claims and the following description of exemplary embodiments of the invention, which is to be understood as non-limiting and which is explained in greater detail below with reference to the drawings.

### BRIEF DESCRIPTION OF THE DRAWINGS

FIG. 1: shows a schematic representation of a steering gear;

FIG. 2: shows a schematic representation of a motor vehicle with a steering gear from FIG. 1;

FIG. 3: partially shows a steering gear of a proposed power steering assembly in a sectional view, in FIG. 3a) in a schematic view, and in FIG. 3b) in a sectional view A-A from FIG. 3a);

FIG. 4: shows separate preload units designed as compensation washers;

FIG. 5: partially shows a steering gear of another proposed power steering assembly in a sectional view, in principle according to section line B-B from FIG. 3a);

FIG. 6: partially shows a steering gear of a proposed power steering assembly in a sectional view, in principle according to section line B-B from FIG. 3a);

FIG. 7: shows an input shaft of a proposed power steering assembly, in FIG. 7a) in a perspective view in an assembled state, in FIG. 7b) in a front view from direction B from FIG. 7a), and in FIG. 7c) in a sectional view according to section A-A in FIG. 7b); and

FIG. 8: shows the input shaft of the proposed power steering assembly from FIG. 7a) in a view of all individual parts in an unassembled state.

### DETAILED DESCRIPTION OF THE DRAWINGS

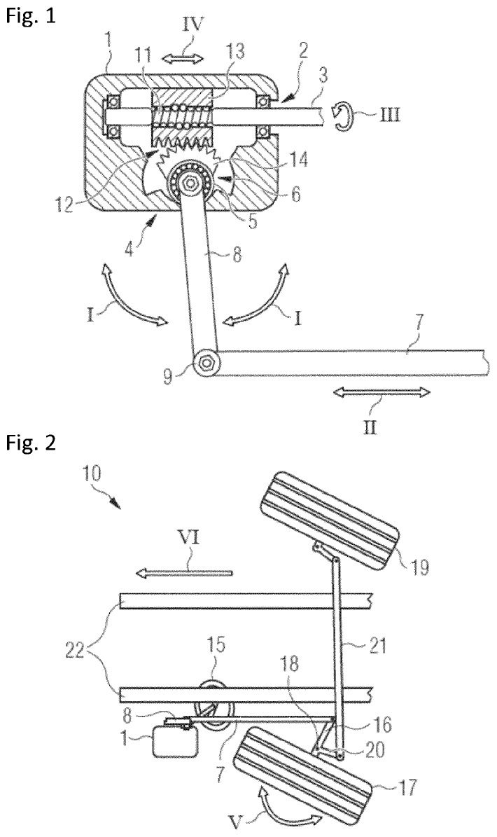

A power steering assembly for electromechanical power steering in motor vehicles is schematically depicted in FIG. 1. The power steering assembly comprises a steering gear 1. A steering movement performed by the driver of the motor vehicle with a steering input device, such as a steering wheel (not shown in FIG. 1), for example, is translated via the steering gear 1. For this purpose, a rotational movement introduced via an input side 2 of the steering gear 1, specifically via an input shaft 3 in the illustrated case, is transmitted to an output side 4 of the steering gear 1.

On the output side 4 of the steering gear 1, a movement, in the specific case represented, a rotational movement of an output shaft 6 designed as a segment shaft 5 of the steering gear 1, is derived. This movement, derived on the output side 4, which is indicated in the case represented here by two curved double arrows I, is ultimately received in the non-limiting exemplary embodiment represented here by a tie rod 7 of the power steering assembly. Consequently, the tie rod 7 performs a translational tie rod movement. The translational tie rod movement of the tie rod 7 is a linear movement indicated by a double arrow II in FIG. 1, finally resulting in at least one wheel of the motor vehicle turning about a steering axle (not shown in FIG. 1), so that the vehicle completes the desired cornering as a result.

In order to convert the rotational movement (double arrows I) derived at the output side 4 into the desired translational tie rod movement (double arrow II) of the tie rod 7, the power steering assembly illustrated has a steering column lever 8 and a joint in the form of a ball joint 9 connecting the steering column lever 8 to the tie rod 7.

In the following description of a normal steering action, reference is made both to FIG. 1 and to FIG. 2, which shows a schematic representation of a motor vehicle 10 from below with a power steering assembly with the steering gear 1 from FIG. 1.

For motor vehicles 10 in the form of commercial vehicles, ball recirculating steering gears are normally used for so-called recirculating ball steering (abbreviated to RBS). The kinematics of this kind of arrangement are particularly favorable for commercial vehicles, as they usually have a front axle in the form of a solid front axle. If the longitudinal arms of the front axle and the tie rod are approximately the same length and arranged substantially parallel to one another, they form a parallelogram. Consequently, the compression movements of the front axle have little or no effect. Insofar as the steering gear 1 is rigidly mounted to the chassis, length compensation can be achieved in the steering column, for example through a corresponding relative movement between a chassis of the motor vehicle 10 and the driver's cab. Given that commercial vehicles are an application for which the proposed power steering assembly is particularly suited, the invention is explained below using the example of recirculating ball steering.

The steering gear 1 comprises an input shaft 3, which is sectionally formed as a spindle 11, as well as a ball screw nut 13 with external teeth 12 arranged in the region of the spindle 11. Segment teeth 14 are engaged with the external teeth 12. The segment teeth 14 and the external teeth 12 are arranged meshed together. Furthermore, the segment teeth 14 are connected to the output shaft 6 in a rotatably fixed, that is, non-rotatable, manner, which output shaft is therefore designed as a segment shaft 5. The steering column lever 8 is in turn connected to the output shaft 6 in a rotatably fixed or non-rotatable manner, wherein, as previously described, the steering column lever 8 is movably connected to the tie rod 7 via the ball joint 9.

In the steering gear 1, the turning of a steering input device, specifically a steering wheel 15 (FIG. 2), is transferred via the steering column and the input shaft 3 to the spindle 11. The input shaft 3 may be a part of the steering column, for example. The spindle 11 is also referred to as a ball screw spindle or, occasionally, as a worm. This rotational movement of the input shaft 3, which is marked by an arrow III indicating a circular movement in FIG. 1, is converted into a linear movement of the ball screw nut 13, and therefore also of the external teeth 12 of the ball screw nut 13, by means of the ball screw nut 13. This linear movement of the ball screw nut 13 and the external teeth 12 is marked by a double arrow IV in FIG. 1.

Through the gear pairing of the external teeth 12 and the segment teeth 14, the linear movement marked by the double arrow IV is then transformed into the previously described rotational movement of the output shaft 6, which is derived at the output side 4 of the steering gear 1 and marked by the curved double arrows I. The linear movement (double arrow IV) is therefore ultimately also converted into the rotational movement of the steering column lever 8 (double arrows I). At the end of the steering column lever 8, the tie rod 7 is in turn moved predominantly linearly. As can be seen from FIG. 2, the tie rod 7 ultimately pivots the wheel 17 to be steered about the steering axle 18 via a steering column lever 16 fastened to the wheel carrier. This rotational movement of the wheel 17 is indicated by the curved double arrow V in FIG. 2. In this case, another wheel 19 located opposite the wheel 17 can be co-steered via a track control arm 20 and a solid tie rod 21.

With reference to FIG. 1, it is apparent that the rotational movement derived from the output side 4 (double arrows I) is transmitted to the tie rod 7 via the ball joint 9 in such a manner that the tie rod 7 performs the translational tie rod movement (double arrow II) necessary for the intended steering of the wheel 17, or the wheels 17, 19.

Furthermore, FIG. 2 shows a chassis 22 of the motor vehicle 10 in the form of two longitudinal members arranged parallel to one another. The steering gear 1 can be mounted on the chassis 22 of the motor vehicle 10 by means of a mounting arrangement not shown in FIGS. 1 and 2, for example in that longitudinal members of the chassis 22 and housing of the steering gear 1 can be connected to one another by fastening screws. The direction of travel of the motor vehicle 10 is indicated by an arrow VI in FIG. 2.

The steering gear 1 preferably incorporates hydraulic power assistance. For this purpose, the ball screw nut 13 is sealed against a housing of the steering gear 1. Consequently, the ball screw nut 13 can function as a so-called hydraulic piston, also simply referred to as a piston. The ball screw steering comprises, accordingly, two oil chambers which are separated from one another and on opposite sides of the piston, providing hydraulic steering assistance. A differential pressure between the two sides of the ball screw nut 13 can then be generated, typically by means of a rotary valve, via the steering moment introduced by the driver on the input shaft 3. This differential pressure can assist the movement of the ball screw nut 13.

The power steering assembly that has been described comprises multiple mechanically sensitive components for achieving the desired steering movement, particularly in the steering gear 1. It is particularly important for these components to be protected from abrupt movements that can result from vibrations and, finally, from unwanted forces being transmitted via the wheels 17, 19 into the steering gear 1. Forces and loads or tensions of this kind can arise if, for example, road surface irregularities lead to shocks that are transmitted through the wheels 17, 19. To this extent, it is particularly desirable for road-induced shock impulses of this kind to be dampened or compensated towards the steering gear 1, and for damage to components of the steering gear 1 to be prevented. In particular, detrimental shocks of this kind can be transmitted via the wheels 17, 19 in the exemplary embodiment shown, and then along the tie rod 7 as far as the steering gear 1, as a result of which damage could be caused to sensitive components of the steering gear 1.

Here, the present invention provides an advantageous solution. Essential to this is, on the one hand, the provision of an adjustable absorption unit 23 designed to absorb road-induced shocks received via the wheel 17, 19 of the motor vehicle 10.

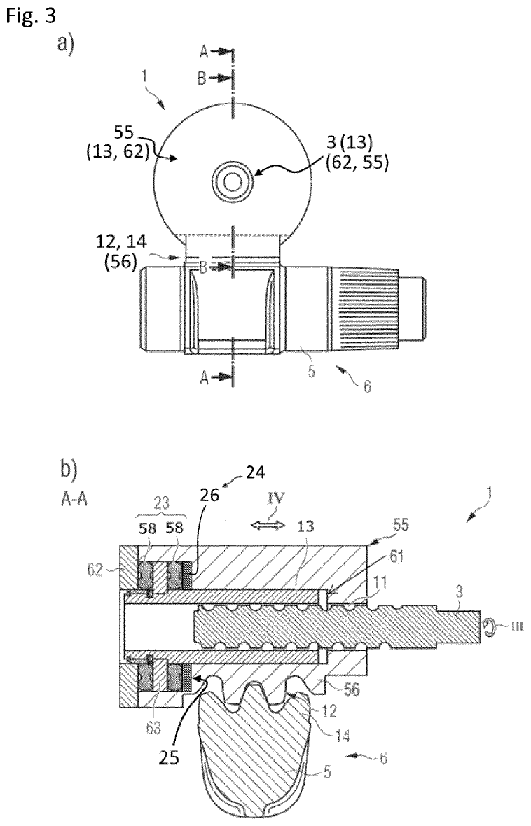

The adjustable absorption unit 23 in this case can be provided at a wide variety of points or nodes in the power steering assembly, as exemplified in the exemplary embodiments shown in FIGS. 3 to 8. The adjustable absorption unit 23 in this case is preferably formed by at least one energy-absorbing element and is set up for the at least partial conversion of kinetic energy into potential energy.

The adjustable absorption unit 23 is preferably integrated into the power steering assembly for this purpose, in such a manner that components of the power steering assembly which are adjacent to the adjustable absorption unit 23 can execute at least minimal movements relative to one another. To achieve this, the adjustable absorption unit 23 is preferably designed with elasticity or greater flexibility compared with the adjacent components, in particular the immediately adjacent components. In this way, abrupt movements of components in the power steering assembly can be selectively received in the adjustable absorption unit 23, and cushioned or compensated for by said absorption unit. The relative movements selectively permitted in the component, in the form of the adjustable absorption unit 23, facilitate a targeted energy conversion and therefore compensation for the kinetic energy. This substantially reduces the risk of damage to components sensitive to mechanical loads in the steering gear 1.

The adjustability of the adjustable absorption unit 23 is guaranteed in this case by a separate preload unit 24. This separate preload unit 24 works in conjunction with the adjustable absorption unit 23, applying a predetermined preload force to the adjustable absorption unit 23. In particular, the separate preload unit 24 is used to press together, or compress, the adjustable absorption unit 23 by a certain amount. As a result, the adjustable absorption unit 23 exhibits a reduced thickness, in particular substantially in the direction of the force flow of the forces introduced by road-induced shocks which are to be compensated, when the separate preload unit 24 is present, compared with the state when no separate preload unit 24 is present or installed. In this way, a restoring force is selectively generated in the adjustable absorption unit 23.

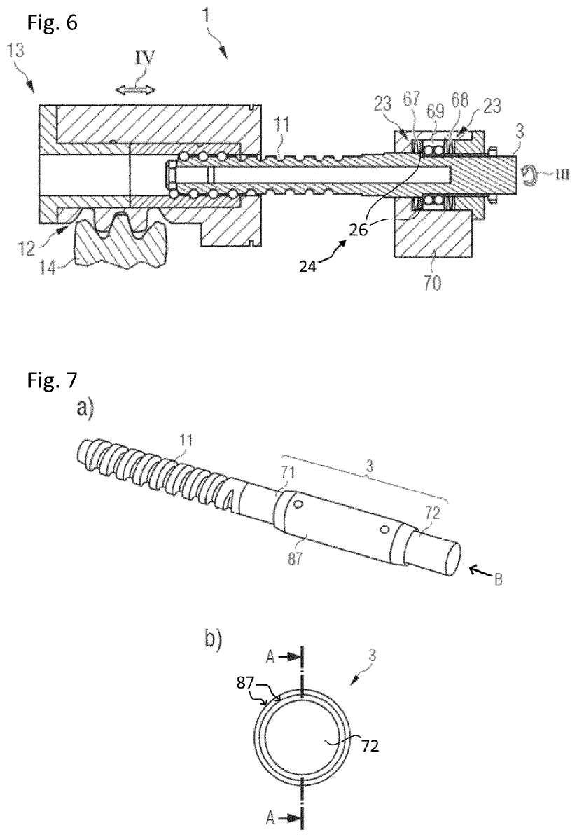

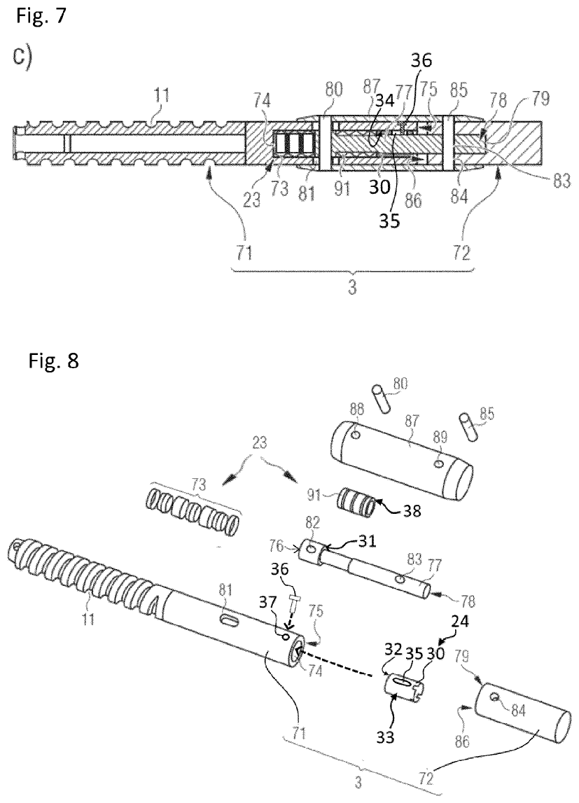

The adjustable absorption unit 23 for absorbing or compensating for road-induced shocks received via the wheel 17 of the motor vehicle 10 can be provided at various points within the power steering assembly. As evident from the following exemplary embodiments in FIGS. 3, 5, 6, 7, and 8, the adjustable absorption unit 23 can, however, be particularly effectively integrated into the steering gear 1 or the attachment thereof to the input shaft 3. Particularly preferably, the adjustable absorption unit 23 in this case is integrated into the design of the ball screw nut 13 or the interaction thereof with the input shaft 3 (cf. FIG. 3, 5), or as part of the bearing arrangement of the input shaft 3 (cf. FIG. 6), or within the design of the input shaft 3 itself (cf. FIG. 7, 8).

A partially schematic representation of the steering gear 1 is provided in FIG. 3a). FIG. 3b) depicts the cross-sectional view A-A from FIG. 3a). FIG. 3a) serves as a sort of schematic overview (with different alternative reference signs provided in parentheses), as FIG. 5 and FIG. 6 also represent in principle the cross-sectional view B-B from FIG. 3a).

FIG. 3b), and also the exemplary embodiment in FIG. 5, illustrates partial views of the steering gear 1 of the corresponding power steering assemblies, as proposed. In both exemplary embodiments, the steering gear 1 features an input shaft 3 configured as a spindle 11, as well as a ball screw nut 13, and also, in addition, a rack 55 for converting the rotational movement of the input shaft 3 (arrow III) into a translational movement (double arrow IV).

In order to transmit this translational movement (double arrow IV), the rack 55 in turn has a tooth section 56 on the outside which constitutes the external gearing 12. The tooth section 56, or the external gearing 12, then engages with the segment shaft 5, which at least partially forms the output side 4 of the steering gear 1 and in turn induces, through its translational movement (double arrow IV), the desired rotational movement of the segment shaft 5 (cf. double arrows I in FIG. 1). Furthermore, the rack 55 forms a separate component from the internal ball screw nut 13.

In order to compensate for road-induced shocks, the adjustable absorption unit 23 of the power steering assemblies shown in FIGS. 3b) and 5 is arranged in such a manner that the translational movement of the ball screw nut 13 (double arrow IV) is transmitted via the adjustable absorption unit 23 to the tooth section 56, and vice versa, in other words, a translational movement of the tooth section 56 is also transmitted via the adjustable absorption unit 23 to the ball screw nut 13. The adjustable absorption unit 23 in this case is made of at least one elastic element, specifically of two disk springs 57 in the variant according to FIG. 5, and in the variant according to FIG. 3b), it is formed from two elastomers 58. Combinations of elastomers, disk springs, or also coil springs are also possible in principle.

Finally, the adjustable absorption unit 23 forms a connecting point between the respective ball screw nut 13 and the tooth section 56, which performs the function of the outer gearing 12 for the gear pairing with the segment shaft 6.

In the direction corresponding to the translational movement of the ball screw nut 13 (double arrow IV), the two components, ball screw nut 13 and rack 55 with tooth section 56, are set up in principle to be movable relative to one another. In turn, in the direction of rotation, so corresponding in principle to the rotational movement of the input shaft 3 (arrow III), the two components, ball screw nut 13 and rack 55 with tooth section 56, are secured to one another in a non-rotatable manner. The ball screw nut 13 cannot therefore be rotated in its receptacle in the rack 55. Keyways for securing may be provided for this purpose, for example. In FIG. 5, the ball bearings 60 of the recirculating ball steering are depicted in addition, while the detailed representation of these is omitted from FIG. 3b).

In the exemplary embodiments shown, the adjustable absorption unit 23 formed from at least one elastic element allows for relative movements in each case of the components adjacent to the adjustable absorption unit 23. These relative movements are possible in the axial direction. During this, the adjustable absorption unit 23 undergoes elastic compression in each case. In this way, the adjustable absorption unit 23 converts kinetic energy into potential energy, as intended, when encountering strong or abrupt movements, for example an abrupt rotation of the output shaft 6, which abrupt movements can be caused by road-induced shocks, for example. As a result, the loads prevailing inside the steering gear 1 which are caused by road-induced shocks can be advantageously compensated.

In the two exemplary embodiments shown in FIGS. 3b) and 5, the ball screw nut 13 is received in a central bore of the rack 55, which has a flat surface 61, and is secured on the opposite side of the flat surface 61 with a cover 62. The cover 62 makes contact for this purpose with the front end of the rack 55 with its circumferential contact surface on the head side, which front end is arranged opposite the flat surface 61 of the central bore.

The covers 62 are each fixedly connected to the rack 55, preferably via the front ends of the rack 55 facing away from the flat surfaces 61 in each case. Furthermore, the cover 62 according to the exemplary embodiment in FIG. 5 has an axially extending insertion section 59 that projects into the central bore of the rack 55.

In the exemplary embodiment according to FIG. 3b), the elastomer 58 shown on the left bears with its left outer end face against an inner part of the circumferential contact surface of the cover 62 on the head side. In the exemplary embodiment according to FIG. 5, the disk spring 57 shown on the right in turn makes contact with its right outer face with an inner end face of the insertion section 59 of the cover 62.

The compensation effect of the road-induced abrupt movements by the adjustable absorption units 23 of the two exemplary embodiments described in FIGS. 3b) and 5 is described below. Specifically, these are primarily situations in which abrupt movements of the output shaft 6 occur which can lead to jerky linear movements in the rack 55, which is engaged with the output shaft 6 through the gear pairing (cf. reference signs 12, 14, 56), according to the two directions indicated by the double arrow IV.

In general, in the two exemplary embodiments shown in FIGS. 3b) and 5, the following applies: Abrupt rotation of the segment shaft 5, and therefore abrupt linear movements of the rack 55 to the left, are initially compensated for in the exemplary embodiment shown in FIG. 3b) by the elastomer 58 shown on the right, and in the exemplary embodiment shown in FIG. 5, by the disk spring 57 shown on the right. The same similarly applies to abrupt linear movements in the respective ball screw nuts 13 to the right, which results in compression of the right elastomer 58 or the right disk spring 57.

The converse applies to the opposite movement directions: Abrupt movements of the respective ball screw nut 13 to the left cause the left elastomer 58, or the left disk springs 57, to be compressed, as a result of which the desired compensation is selectively achieved in each case. A similar thing applies to an abrupt deflection of the output shaft 6, and therefore of the segment gear 14, to the right: The abrupt linear movements of the respective racks 55 to the right cause the left elastomer 58 or the left disk springs 57 to be compressed, as a result of which the desired compensation is selectively achieved in each case.

In detail, the targeted compensation of abrupt movements according to the exemplary embodiment in FIG. 3b) proceeds as follows: If, for instance, the rack 55 moves abruptly to the left, provoked by a sudden pivoting of the segment shaft 5 to the left, for example, this causes the right elastomer 58 to be compressed initially. This right elastomer 58 is received in a central receptacle 25 of the rack 55, wherein at the base of this central receptacle 25, a compensation washer of a preload unit 24 (described in greater detail later) is initially arranged, against which the right elastomer 58 abuts. In any case, the sudden leftward movement from the rack 55 is transmitted to the right elastomer 58 via the base of the central receptacle 25 and the preload unit 24, and then further through an adjacent ring element 63 to the ball screw nut 13.

The compensation for the sudden movement of the rack 55 to the left described here works similarly in the opposite direction too with respect to the force flow, that is, when the cause of the abrupt movement is not, as described earlier, the deflection of the output shaft 6, and therefore of the segment gear 14, to the left, but rather an abrupt movement of the ball screw nut 13 to the right. In this case, the ball screw nut 13 that moves abruptly to the right compresses the right elastomer 58 initially through the movement transmission via the ring element 63, before this right elastomer 58 in turn compensates the movement, as desired, and transmits it to the preload unit 24 or finally to the rack 55, and lastly to the segment gear 14 and the output shaft 6.

Likewise, in the opposite direction, so during an abrupt movement of the rack 55 to the right (caused by an abrupt deflection of the segment shaft 5 to the right, for example), the cover 62 shown on the left edge in FIG. 3b) is initially moved to the right, as it is fixedly connected to the rack 55. As a result of this, the adjacent left elastomer 58 is initially compressed, before the movement is transmitted through the ring element 63 to the ball screw nut 13.

The compensation described here works similarly in the reverse direction with respect to the force flow, that is, when the starting point is not an abrupt movement of the rack 55 to the right, but rather an abrupt movement of the ball screw nut 13 to the left. In this case, the movement of the ball screw nut 13 to the left initially compresses the adjacent left elastomer 58 by means of the ring element 63, as a result of which the desired compensation is achieved before the forces and the movement are transferred to the cover 62 and then to the rack 55, and ultimately to the output shaft 6.

According to the exemplary embodiment FIG. 5, the targeted compensation of abrupt movements proceeds as follows: If, for instance, the rack 55 moves abruptly linearly to the left, due to a sudden deflection of the segment shaft 5 to the left, for example, the right disk spring 57 is initially compressed. This occurs because, together with the rack 55, the cover 62 fixedly connected thereto is likewise moved to the left, along with its insertion section 59. This, in turn, initially compresses the right disk spring 57, leading to the desired compensation of the road-induced shock, before the movement is finally transmitted to the left to the ball screw nut 13 adjacent to the right disk spring 57.

The compensation for the sudden movement of the rack 55 to the left described here works similarly in the opposite direction too with respect to the force flow, that is, if the cause of the abrupt movement is not the deflection of the output shaft 6, and therefore the segment gear 14, to the left, as described earlier, but rather an abrupt movement of the ball screw nut 13 to the right. In this case, the ball screw nut 13 that moves abruptly to the right initially compresses the right disk spring 57, before the disk spring in turn compensates for the movement, passing it on to the cover 62, which then transfers the movement to the rack 55, and finally to the segment gear 14.

Again, in the opposite direction, so when the rack 55 according to FIG. 5 executes a sudden movement to the right, the left disk spring 57 provided in the region of the flat surface 61 is initially compressed, before the corresponding loads are transferred to the ball screw nut 13. Similarly, a sudden, jerky movement of the ball screw nut 13 to the left results in the initial compression of the left disk spring 57, before the forces are finally transmitted through the flat surface 61 to the rack 55, ultimately causing a deflection of the segment gear 14, and therefore the output shaft 6, to the left.

A particular advantage of the proposed power steering assembly is the provision of a separate preload unit 24 that interacts with the adjustable absorption unit 23. A desired, predetermined preload force is applied by this separate preload unit 24 to the adjustable absorption unit 23.

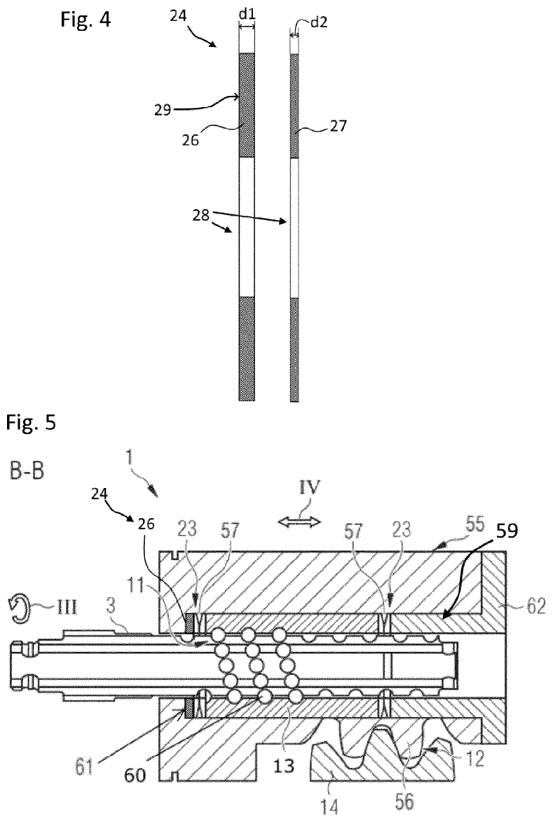

In the exemplary embodiments depicted in FIG. 3b) and FIG. 5, a first compensation washer 26 is specifically used as the separate preload unit 24 in each case. FIG. 4 depicts, in principle, a first compensation washer 26 of this kind, wherein the first compensation washer 26 has a first thickness d1. In addition, a further second compensation washer 27 with a different, in this case smaller, thickness d2 is shown. The compensation washers 26, 27 each have central openings 28 through which, in the assembled state, the ball screw nut 13 and the input shaft 3 (cf. FIG. 3b), or only the input shaft 3 (cf. FIG. 5), can extend.

In principle, multiple compensation washers 26, 27 can also be provided as the separate preload unit 24, and not only a first compensation washer 26 as shown simply by way of example in FIG. 3b) and FIG. 5, in particular in order to selectively adjust the desired preload forces acting on the adjustable absorption units 23.

In concrete terms, the separate preload units 24, in the embodiments described the first compensation washers 25 in each case, each have an end face 29 which acts as a contact surface with the adjustable absorption unit 23 for each setting, in other words preloading, of the absorption unit 23. The first compensation washers 25 and the adjustable absorption unit 23 in each case are arranged adjacent to one another via a contact surface.

Specifically, in FIG. 3b) the first compensation washer 26 is received in the central receptacle 25 of the rack 55. The right elastomer 58 of the adjustable absorption unit 23 is in turn arranged adjacent to the side facing away from the base of the central receptacle 25. The right elastomer 58 is in contact with the end face 29 of the first compensation washer 26 of the separate preload unit 24 (cf. FIG. 4) via its right outer surface on the front end (cf. FIG. 4).

In this way, the separate preload unit 24 with the first compensation washer 26 ensures compression of the adjustable absorption unit 23, specifically the right elastomer 58, compared with a situation in which the first compensation washer 26 is not provided. A predetermined preload force is therefore applied to the adjustable absorption unit 23, which in turn generates a restoring force in this adjustable absorption unit 23.

A power steering assembly can therefore be advantageously set up with the help of the proposed method for setting up a power steering assembly for electromechanical power steering of motor vehicles 10, wherein it may primarily be a previously described power steering assembly, in which the adjustable absorption unit 23 for the at least partial absorption of road-induced shocks absorbed through the wheel 17 or 19 of the motor vehicle 10 is initially integrated into the conversion path of the steering movement of the entire power steering assembly.

A separate preload unit 24 is then provided as proposed. In this case, at least a first compensation washer 26 can be provided as the separate preload unit 24, as shown in the exemplary embodiments in FIGS. 3, 5, and 6, adjacent to the adjustable absorption unit 23, for preloading by targeted compression of the adjustable absorption unit 23. Furthermore, it is also conceivable for a second compensation washer 27 to be provided adjacent to the adjustable absorption unit 23 for preloading by targeted compression of the adjustable absorption unit 23 (cf. FIG. 4). In this case, the second compensation washer 27 may advantageously have a second thickness d2 that differs from a first thickness d1 of the first compensation washer 26.

With the help of separate preload units 24 of this kind, an individually desired, predetermined preload force is finally set according to the proposed method, which is applied to the adjustable absorption unit 23 in that the separate preload unit 24 compresses the adjustable absorption unit 23. During this, the adjustable absorption unit 23 is compressed by a certain predetermined amount. This amount can be chosen, for example, as in the exemplary embodiments in FIGS. 3, 5, and 6, via the thickness of the selected compensation washers 26, 27, for example via the first thickness d1 of the first compensation washer 26 (cf. FIG. 4). The degree of compression, and therefore also the preload force, can also be adjusted via the process step of screwing in a preload nut 30, for example, as a result of which substantially continuous adjustability is guaranteed (cf. FIGS. 7 and 8 and the corresponding description).

Further embodiments of an adjustable absorption unit 23 of the proposed power steering assembly are depicted in FIGS. 6, 7, and 8. In the exemplary embodiments shown, the steering gear 1 has an input shaft 3 formed as a spindle 11 and a ball screw nut 13 for converting the rotational movement of the input shaft 3 (arrow III) into a translational movement (double arrow IV). The adjustable absorption unit 23 in this case is at least partially formed as an axial elastic spindle bearing for the input shaft 3.

In the exemplary embodiment according to FIG. 6, the adjustable absorption unit 23 formed as an axial elastic spindle bearing for the input shaft 3 is made up of two elastic elements, specifically the disk spring 67 and the disk spring 68. The disk springs 67 and 68 in this case are arranged adjacent to a bearing arrangement of the input shaft 3 for the rotatable bearing of the input shaft 3, specifically adjacent to the double-row angular contact ball bearing 69, in a housing 70, in such a manner that the bearing arrangement of the input shaft 3 is received in the housing 70 in an axially elastic manner via the disk springs. The separate preload unit 24 with a first compensation washer 26 is arranged between the left disk spring 67 and the angular contact ball bearing 69.

With the help of the adjustable absorption unit 23 shown in the form of the two disk springs 67, 68, road-induced shocks that can be introduced, for example, via the segment shaft 6 with the segment gear 14, can be selectively compensated for. Hence, when the input shaft 3 rotates (arrow III), a sleeve enclosing the input shaft 3 and the inner ring of the angular contact ball bearing 69 also rotate. The outer ring of the angular contact ball bearing 69, in turn, is arranged in the housing 70 of the steering gear in a rotationally fixed but axially movable manner.

In turn, the adjustable absorption unit 23, in the form of the disk springs 67, 68, is located on both sides, in other words, the disk spring 67 on the left, and the disk spring 68 on the right, against the outer ring of the angular contact ball bearing 69. However, the left disk spring 67 in this case is not directly, but only indirectly, adjacent to the outer ring of the angular contact ball bearing 69. The first compensation washer 26 is therefore arranged between the disk spring 67 and the outer ring of the angular contact ball bearing 69.

According to the proposal, in the case of shocks on the spindle side, an axial damped movement takes place, as the disk spring 67 shown on the left is compressed during an abrupt movement of the input shaft 3 to the left, and the disk spring 68 shown on the right is compressed during an abrupt movement of the input shaft 3 to the right. The inner diameter of the disk springs 67, 68 is greater than the diameter of the sleeve or the input shaft 3. Consequently, the adjustable absorption unit 23 which is shown again allows for targeted small relative movements of the adjacent components of the power steering assembly, which in turn ensures a targeted conversion of kinetic energy into potential energy and, therefore, also compensation for road-induced shocks. The separate preload unit 24 with the first compensation washer 26 in turn provides for targeted preloading of the disk spring 67 shown on the left in this case.

In the exemplary embodiment according to FIGS. 7 and 8, the input shaft 3 designed as a spindle 11 is divided into multiple parts by at least one spindle section 71 facing the ball screw nut 13 and an input section 72. In FIG. 7a), the input shaft 3 is shown in the mounted state in a perspective view, while FIG. 7b) shows the corresponding input shaft 3 in a front view according to arrow B from FIG. 7a). In FIG. 7c), the input shaft 3 is then shown in a longitudinal section corresponding to the section A-A from FIG. 7b). FIG. 8, in turn, shows the same input shaft 3, but in a non-assembled state, in other words broken down into individual components for illustration purposes.

The spindle section 71 and the input section 72 of the input shaft 3 are connected to one another in a rotationally fixed manner. However, the spindle section 71 and the input section 72 are also connected to one another in an axially elastic manner via the adjustable absorption unit 23 formed as an axial elastic spindle bearing for the input shaft 3. The axial elastic spindle bearing in this case is formed by elastic elements, namely, in the present case, firstly by a package of annular springs 73 shown on the left, and secondly by the right package of annular springs 91.

The annular springs 73 shown on the left are arranged between the spindle section 71 and the input section 72. Specifically, the annular springs 73 shown on the left are received in a central receptacle 74 at the end 75 of the spindle section 71 facing the input section 72. On the side facing away from the base of the receptacle 74, the annular springs 73 bear against an end face 76 of a connecting push rod 77. This connecting push rod 77 is also largely received in the receptacle 74 of the spindle section 71, but the end 78 of the connecting push rod 77 facing the input section 72 of the input shaft 3 protrudes from the receptacle 74, and therefore from the end 75 of the spindle section 71.

The connecting push rod 77 ensures the torsionally rigid connection of the spindle section 71 to the input section 72 of the input shaft 3. For this purpose, as described, the connecting push rod 77 is received in the receptacle 74 of the spindle section 71 in each case and a receptacle 79 of the input section 72 and is connected to the respective component in a rotationally fixed manner. For this purpose, a spindle-side connecting pin 80 is firstly provided which, in the assembled state, extends through both an elongated hole 81 in the spindle section 71 and through a spindle-side through-hole 82 in the connecting push rod 77 (in the interests of clarity, the through-hole 82 is only marked in FIG. 8). The elongated hole 81 is also designed as a through-hole for this purpose. The elongated hole 81 and the spindle-side through-hole 82 are aligned with one another in the assembled state for this purpose. The elongated hole 81 has a greater axial extent relative to the axis of the input shaft 3 than the spindle-side through-hole 82.

On the side facing the input section 72, the connecting push rod 77 again has an input-side through-hole 83 (in the interests of clarity, the through-hole 83 is only marked in FIG. 8). In addition, the input section 72 of the input shaft 3 also has a through-hole 84, which is brought into alignment with the input-side through-hole 83 in the assembled state. An input-side connecting pin 85 in turn extends through both the through-hole 84 and the input-side through-hole 83 in the assembled state, so that the input section 72 and the connecting push rod 77 are connected to one another in a rotationally fixed manner. Furthermore, the input section 72 and the connecting push rod 77 are also connected to one another in an axially fixed manner, since both the through-hole 84 and the input-side through-hole 83 have substantially the same diameter, and the input-side connecting pin 85 in turn connects the two components to one another in a form-fitted manner viewed in the axial direction too.

With the arrangement described, the input section 72 and the spindle section 71 are connected to one another in a rotationally fixed manner by means of the components of the spindle-side connecting pin 80, the input-side connecting pin 85, and the connecting push rod 77. In this case, there is sufficient clearance between the two facing ends of the two components, namely between the end 75 of the spindle section 71 facing the input section 72 and the end 86 of the input section 72 facing the spindle section 71, to allow for minor axial relative movements between the spindle section 71 and the input section 72. Also, due to the fact that the spindle-side connecting pin 80 is received with axial clearance in the elongated hole 81 of the spindle section 71, the connecting push rod 77 can therefore move axially relative to the spindle section 71.

Small axial relative movements of this kind are used as intended to dampen or compensate for road-induced shock impulses. The adjustable absorption unit 23 in the form of the annular springs 73 shown on the left, which are arranged bearing against the end face 76 of the connecting push rod 77 in the receptacle 74 of the spindle section 71, as well as in the form of the right package of annular springs 91 is ultimately used for this purpose. The relative movements which are absorbed by the adjustable absorption unit 23 are used to convert kinetic energy into potential energy, as intended, and the road-induced shocks are therefore compensated for.

Furthermore, the preload nut 30 is provided as a separate preload unit 24 according to the proposal. The preload nut 30 partially surrounds the connecting push rod 77 on the outer side. The annular springs 91 of the package of annular springs 91 shown on the right are arranged adjacent to the preload nut 30 viewed in the axial direction. Specifically, the annular springs 91 shown on the right are likewise arranged surrounding the connecting push rod 77. In this case, the annular springs 91 are arranged on the left side, so bearing against an axial push rod abutment surface 31 in the direction towards the spindle section 71. On the right side, in turn, so in the direction towards the input section 72, the annular springs 91 are arranged bearing against an axial end face 32 of the preload nut 30. This axial end face 32 of the preload nut 30 therefore forms the contact surface between the annular springs 91 of the adjustable absorption unit 23 and the separate preload unit 24.

In the exemplary embodiment shown in FIGS. 7 and 8, two interlocking threads are part of the separate preload unit 24. On one hand, the outer lateral surface of the preload nut 30 has a thread 33 (in the interest of clarity, only marked with an arrow in FIG. 8). On the other hand, the partially inwardly hollow spindle section 71 of the input shaft 3 in turn has a counter-thread 34 matching the thread 33. In this way, the preload nut 30, as the first component, and the spindle section 71 of the input shaft 3, as the second component, are engaged with one another. This means that the separate preload unit 24 is set up to cooperate with the adjustable absorption unit 23, in such a manner that the predetermined preload force can be adjusted by means of the two components, in the form of the preload nut 30 and the spindle section 71, which are engaged with one another via the thread 33 and counter-thread 34. In this case, the two components are adjustable in a substantially continuous manner. This allows the preload nut 30 to change its axial position relative to the spindle section 71 of the input shaft 3 at random, at least within a certain range.

Depending on how far the preload nut 30 is inserted into the receptacle 74 of the spindle section 71 (indicated by the dashed arrow in FIG. 8) and finally turned into the counter-thread 33, the right package of annular springs 91 is compressed to a greater or lesser extent.

So that the preload nut 30 is secured to prevent the thread 33 from turning again in the counter-thread 34, a locking mechanism can be provided, as illustrated here. For this purpose, in the exemplary embodiment shown in FIGS. 7 and 8, the preload nut has a groove 35. Multiple grooves can also be provided at various points on the outer lateral surface of the preload nut 30. To secure against rotation, a locking pin 36 is provided in the assembled state, which engages both with the groove 35 in the preload nut 30 and with the outer surface-side bore 37 in the spindle section 71 of the input shaft 3 (cf. combination of FIGS. 7c) and 8). Through the form-fitting receiving of the locking pin 36 in the bore 37 and, equally, the form-fitting receiving of the locking pin 36 viewed in the circumferential direction in the groove 35, the preload nut 30 is secured against rotation, so connected to the spindle section 71 of the input shaft 3 in a substantially torsionally rigid or rotationally fixed manner.

Viewed in the axial direction, the preload nut 30 is arranged surrounding the internal connecting push rod 77 in such a manner that the preload nut 30 is axially movable relative to the connecting push rod 77. This means that the preload nut 30 can change its position in the axial direction relative to the connecting push rod 77. Therefore, despite the secured position of the preload nut 30 in the axial and circumferential directions with respect to the spindle section 71, at least small axial relative movements of the spindle section 71 of the input shaft 3 relative to the connecting push rod 77, and therefore to the input section 72 of the input shaft 3, are possible, as have previously already been described in detail. The axial clearance is also provided by the fact that the groove 35 is designed as an elongated hole, allowing the locking pin 36 to move back and forth along the axial direction to a certain extent.

The preload nut 30 presses its axial end face 32 against an axial abutment face 38 of the annular springs 91, compresses them and, by compressing the annular springs 91, thereby exerts the desired predetermined preload force on the adjustable absorption unit 23.

According to the proposed method for setting up the power steering assembly partially depicted in FIGS. 7 and 8, it is therefore provided that the preload nut 30 is provided as a separate preload unit 24, adjacent to the adjustable absorption unit 23, specifically to the right package of annular springs 91 and, in particular, to the axial abutment surface 38 of these annular springs 91, to preload by targeted compression of the adjustable absorption unit 23. In this case, the predetermined preload force is adjusted by rotating in respect of one another the first component of the separate preload unit 24, which has the thread 33, in the form of the preload nut 30, and the second component engaged with the first component, which has the counter-thread 34, in the form of the spindle section 71 of the input shaft 3. The extent by which the thread 33 is turned into the counter-thread 34 in this case is determined by the degree of compression of the annular springs 91, and therefore the preload force that has been set.

The power steering assembly shown advantageously compensates for road-induced shocks as follows: The input section 72 of the input shaft 3 is axially and radially mounted in its position. Shocks acting on the spindle 11 are dampened or compensated for by the packages of annular springs 73 and 91. For example, if the spindle 11 moves towards the input section 72 to the right, the left package of annular springs 73 is initially compressed before this movement is finally transmitted to the connecting push rod 77, and therefore to the input section 72 of the input shaft 3.

Shocks resulting in abrupt movements of the input section 72 of the input shaft 3, either to the left, so in the direction of the spindle section 71, or to the right, so away from the spindle section 71, are compensated for as follows: When the input section 72 moves to the left, the connecting push rod 77 also moves to the left, causing the left package of annular springs 73 to be initially compressed in turn, before the movement is transmitted to the spindle section 71. Conversely, when the input section 72 moves to the right, the connecting push rod 77 moves to the right, causing the right package of annular springs 91 to be initially compressed by the axial push rod abutment surface 31. The movement is then transmitted via the axial end face 32 of the preload nut 30 to precisely that preload nut 30, and therefore also to the spindle section 71 which is fixedly connected to the preload nut 30.

Finally, an externally arranged protective sleeve 87 is provided, which also has a spindle-side through-hole 88 and an input-side through-hole 89. The spindle-side through-hole 88 is brought into alignment with the spindle-side through-hole 82 of the connecting push rod 77 and the elongated hole 81 in the spindle section 71. Furthermore, the spindle-side connecting pin 80 also extends through the spindle-side through-hole 88 of the protective sleeve 87. The input-side through-hole 89, in turn, is brought into alignment with the input-side through-hole 83 in the connecting push rod 77 and the through-hole 84 in the input section 72. In addition, the input-side connecting pin 85 also extends through the spindle-side through-hole 89 in the protective sleeve 87.

The protective sleeve therefore particularly surrounds the connecting push rod 77 on the outside and also, in addition, the axial space between the spindle section 71 and the input section 72. Furthermore, the protective sleeve ensures outside guidance of the two components of the input shaft 3 executed separately from one another, namely the spindle section 71 and the input section 72.

### LIST OF REFERENCE SIGNS

1 steering gear
2 input side (of the steering gear 1)
3 input shaft
4 output side (of the steering gear 1)
5 segment shaft
6 output shaft
7 tie rod
8 steering column lever
9 ball joint
10 motor vehicle
11 spindle
12 external teeth (of the ball screw nut 13)
13 ball screw nut
14 segment teeth (of the segment shaft 5)
15 steering wheel
16 steering column lever
17, 19 wheels (of the motor vehicle 10)
18 steering axle
20 track control arm
21 tie rod
22 chassis (of the motor vehicle 10)
23 adjustable absorption unit
24 preload unit
25 central receptacle (of the rack 55)
26 first compensation washer
27 second compensation washer
28 opening
29 end face (of the preload unit 24)
30 preload nut
31 axial push rod abutment surface
32 end face (of the preload nut 30)
33 thread
34 counter-thread
35 groove
36 locking pin
37 outer surface-side bore (of the spindle section 71)
38 axial abutment surface (of the annular springs 91)
55 rack
56 tooth section
57 disk springs
58 elastomer
59 axially extending insertion section (of the cover 61)
60 ball bearings
61 flat surface (of the central bore in the rack 55)
62 cover
63 ring element
67, 68 disk springs
69 angular contact ball bearing (double-row)
70 housing (of the steering gear)
71 spindle section (of the input shaft 3)
72 input section (of the input shaft 3)
73 annular springs
74 receptacle (in the spindle section 71)
75 end of the spindle section 71 (facing the input section 72)
76 end face (of the connecting push rod 77)
77 connecting push rod
78 end of the connecting push rod 77 (facing the input section 72)
79 receptacle (in the input section 72)
80 spindle-side connecting pin
81 elongated hole (in the spindle section 71)
82 spindle-side through-hole (in the connecting push rod 77)
83 input-side through-hole (in the connecting push rod 77)
84 through-hole (in the input section 72)
85 input-side connecting pin
86 end of the input section 72 (facing the spindle section 71)
87 protective sleeve
88 spindle-side through-hole (in the protective sleeve)
89 input-side through-hole (in the protective sleeve)
91 annular springs

1.-15. (canceled)

16. A power steering assembly for electromechanical power steering in a motor vehicle, comprising:
a steering gear, wherein the steering gear is configured to transmit a rotational movement introduced by a steering device through an input side of the steering gear, to an output side of the steering gear, and wherein the power steering assembly is configured to convert a movement derived from the output side of the steering gear into a rotational movement of at least one wheel of the motor vehicle about a steering axle;
an adjustable absorption unit for at least partial absorption of road-induced shocks received through the at least one wheel of the motor vehicle; and
a separate preload unit, which separate preload unit is configured to interact with the adjustable absorption unit such that a predetermined preload force is applied to the adjustable absorption unit.

17. The power steering assembly as claimed in claim 16, wherein
the separate preload unit comprises at least one first compensation washer.

18. The power steering assembly as claimed in claim 17, wherein
the separate preload unit further comprises at least one second compensation washer, a second thickness of which differs from a first thickness of the first compensation washer.

19. The power steering assembly as claimed in claim 16, wherein
the separate preload unit comprises a preload nut.

20. The power steering assembly as claimed in claim 16, wherein
the separate preload unit is configured to interact with the adjustable absorption unit such that the predetermined preload force is adjustable via two components engaging with one another substantially continuously via a thread and a counter-thread.

21. The power steering assembly as claimed in claim 16, wherein
the separate preload unit and the adjustable absorption unit are at least partially movable in relation to one other, in an assembled state, in an axial direction.

22. The power steering assembly as claimed in claim 21, wherein
the separate preload unit is secured in the assembled state to prevent rotation in a circumferential direction, via a securing pin engaging with a groove.

23. The power steering assembly as claimed in claim 16, wherein
the separate preload unit has an end face, which end face forms a contact surface for directly bearing against the adjustable absorption unit, for applying the predetermined preload force to the adjustable absorption unit.

24. A method for configuring a power steering assembly for electromechanical power steering in a motor vehicle, comprising:
integrating an adjustable absorption unit for the at least partial absorption of road-induced shocks received through a wheel of the motor vehicle into a conversion path of a steering movement of the power steering assembly;
providing a separate preload unit; and
finally setting a predetermined preload force, which predetermined preload force is applied to the adjustable absorption unit, wherein the separate preload unit compresses the adjustable absorption unit.

25. The method as claimed in claim 24, wherein, as the separate preload unit, a first compensation washer is provided adjacent to the adjustable absorption unit for preloading the adjustable absorption unit by targeted compression.

26. The method as claimed in claim 25, wherein, a second compensation washer is provided adjacent to the adjustable absorption unit for preloading the adjustable absorption unit by targeted compression, wherein, the second compensation washer has a second thickness that differs from a first thickness of the first compensation washer.

27. The method as claimed in claim 24, wherein, as the separate preload unit, a preload nut is provided adjacent to the adjustable absorption unit for preloading the adjustable absorption unit by targeted compression.

28. The method as claimed in claim 24, wherein the predetermined preload force is set by rotating a first component with a thread of the separate preload unit and a second component with a counter-thread engaging with the first component with respect to one another.

29. The method as claimed in claim 24, wherein the separate preload unit is finally secured to prevent rotation in a circumferential direction.

30. The method as claimed in claim 29, wherein securing is achieved by providing a securing pin that engages with a groove in the circumferential direction in a form-fitting manner.
